(19) United States
(12) Patent Application Publication
(10) Pub. No.: US 2008/0121124 A1
(43) Pub. Date: May 29, 2008

(54) Screen Printer

(75) Inventor: Eiji Sato, Nagaoka-shi (JP)

Correspondence Address: DARBY & DARBY P.C., P.O. BOX 770, Church Street Station, New York, NY, 10008-0770, US

(73) Assignee: PRODUCE CO., LTD., Niigata (JP)

(21) Appl. No.: 11/722,274

(22) PCT Filed: Apr. 17, 2006
(86) PCT No.: PCT/JP06/08078

§ 371 Date: Jun. 20, 2007

(30) Foreign Application Priority Data
Apr. 24, 2005 (JP) 2005-153030

(51) Int. Cl. B05C 17/00

(52) U.S. Cl. 101/123

(57) ABSTRACT

A screen printer having a resolution reproducibility equivalent to that of the photography method, a uniform dimension accuracy, a high aspect ratio (ratio of the line height to the line width), an easy productivity, and a low simple cost. The screen printer, or a screen printing means, comprises drive means for driving a support supporting a screen plate in a vertical direction, the support supporting the screen plate movable by the drive means in a vertical direction, a print holding stage for supporting an object to be printed at a place where the object is brought into contact with a printing surface, and a squeegee of a squeegee unit for transferring a paint onto the object through a paint passing portion of the screen plate by daubing the paint on the screen plate.

### TECHNICAL FIELD

The present invention relates to a screen printing technique and provides a technique that enables high printing precision, a high aspect ratio, easy separation of the screen plate from the object being printed, and thick-application printing.

### BACKGROUND ART

Conventional techniques for printing by a process in which a screen plate is held in place by a magnet, and printing pressure is applied to the surface of the screen plate by a squeegee have been proposed in Patent Document 1 and other publications, for example.

Patent Document 1: Japanese Patent Application Laid-Open No. 7-1702

### DISCLOSURE OF THE INVENTION

### Problems the Invention is Intended to Solve

In screen printing, since coating material held in a screen plate as a printing negative plate that has passed through coating material application is adhered to a printed object by a squeegee, a relatively thick coating can be formed that corresponds to the thickness of the screen plate. Screen printing is superior in this regard to relief printing or surface printing. When a thick coating can be obtained, not only can a sense of depth be created in printing but adaptation can also be made to the manufacture of etching resists or printing substrates in semiconductor manufacturing. Therefore, demand in industrial fields has also increased, and a technique is needed for forming even thicker coatings in a wide range of applications.

However, when the thickness of the screen plate is increased by a certain degree in the conventional technique, the viscosity of the coating material increases and the frictional pressure created by the squeegee on the screen plate must be increased. This increase creates drawbacks in that the screen plate and the printed object easily become misaligned in the area of friction with the squeegee, and the precision of the printed image is adversely affected.

A method for eliminating misalignment with the screen plate due to frictional pressure of the squeegee by using a magnet to attach the screen plate is proposed in Patent Document 1 and other publications. In this method, the screen plate is held by a magnet that is disposed in a printed-object holder on an alignment table. Drawbacks of this method are that “wrinkles” or “waves” are created in the printed object or the screen plate by the magnetic attachment. After the magnetic attachment is released, the coating material does not smoothly separate when the screen plate is separated, and the coating material does not have a neat appearance on the screen plate.

There is thus a need for a screen printer that is capable of overcoming the abovementioned drawbacks, such as a screen printer that can overcome the defects or problems described above, create printing that has a high aspect ratio (ratio of line height to line width) and a high coating thickness, facilitate the separation of the screen plate from the printed object, and easily produce high precision in screen printing.

### Means for Solving these Problems

A first aspect of the present invention uses support body drive means for supporting a screen plate having a coating material passage part that forms a shape to be printed between support bodies capable of operating upward and downward, and means for discharging a coating material from a squeegee unit disposed in a position above the screen plate from a coating material feeding port, moving the coating material on the screen plate using the squeegee, and transferring the coating material to a printed object through the coating material passage part of the screen plate.

According to a second aspect of the present invention, the drive means is configured so as to move one of the support bodies to a high position and peel the screen plate from a printed object using a distal end of the squeegee as a support.

A third aspect of the present invention comprises a support body drive means for driving the support bodies upward and downward, a mechanism for operating in conjunction with the drive means of the support body and fixing an end of the screen plate, and a tension mechanism for applying tension to an end of the screen plate. The tension applied to the screen plate can thereby be kept constant in order to prevent “wrinkles” and “waves” from occurring in the screen plate regardless of the vertical movement of the support bodies.

A fourth aspect of the present invention is a control unit. The control unit has a numeric control device of the support body drive means that enables upward and downward driving of the support body; a numeric control device of squeegee vertical drive means for driving the squeegee upward and downward; and a numeric control device of squeegee horizontal control means for driving the squeegee in a horizontal direction. Means are thus used for setting parameters and automatically performing screen printing in an optimal state through driving the support bodies upward and downward, driving the squeegee upward and downward, and driving the squeegee horizontally to the left and right.

A fifth aspect of the present invention further comprises squeegee horizontal drive means for moving the squeegee in a horizontal direction, wherein the support body drive means is configured so that a coating material is transferred to a printed object through the coating material passage part by movement of the squeegee, and the support body positioned on an opposite side in a movement direction of the squeegee is moved in a direction in which the screen plate is separated from the printed object.

A sixth aspect of the present invention comprises a control device for controlling a position of the support body in a vertical direction via the support body drive means so that a peeling angle of the screen plate is constant when the screen plate is peeled from the printed object while the squeegee is moved.

According to a seventh aspect of the present invention, a servo motor is used as a drive source of the support body drive means, the squeegee vertical drive means, and the squeegee horizontal drive means.

An eight aspect of the present invention further comprises a fixing mechanism for fixing an end part of the screen plate, wherein the fixing mechanism is provided so as to be able to rotate with respect to the support body.

A ninth aspect of the present invention further comprises a tilt mechanism for tilting one of the support bodies towards the screen plate when the support body is moved to a high position.

According to a tenth aspect of the present invention, a fixing mechanism for fixing one end and another end of the screen plate is provided to each of the one support body and the other support body, and the fixing mechanism provided to at least the other support body is allowed to rotate with respect to the other support body.

### EFFECTS OF THE INVENTION

Through the upward and downward movement of the support bodies according to the first aspect, an arbitrary gap can be provided between the back surface of the screen plate and the surface of the printed object when the printed object is set in the printed-object holder and supported in the position in which printing of the screen plate is performed on a sliding table, the printed object can be prevented from interfering with the screen plate, and the printed object can easily be set under the screen plate. Through the upward and downward movement of the support bodies, the movement speed of the support bodies can be adjusted so that the printed coating material does not peel from the printed object, and peeling can be completed with the screen plate in the optimum position.

In the screen printer according to the second aspect, after printing using the squeegee, the screen plate can immediately be peeled from the printed object by raising the support bodies using the distal end of the squeegee as a support point, and peeling can be performed rapidly while the coating material is still soft and of a low viscosity.

Automatically controlling the peel speed and the amount of height movement of the screen plate and the support bodies in this manner makes it possible to provide precise and thick screen printing by a simple operation.

According to the third aspect of the present invention, an appropriate amount of tension can be applied to the screen plate by a tensioning and fixing mechanism for tensioning and fixing an end of the screen plate. Since the tension mechanism and the fixing mechanism can be driven in conjunction with the upward and downward driving of the support bodies, “wrinkles” and “waves” can be prevented in the screen plate at all times.

According to the fourth aspect of the present invention, a parameter for numeric control is set for the relationship between the speed and the amount of movement of the squeegee horizontally and vertically, the support bodies can be moved to the optimum height through numeric control in screen printing of the coating material, and printing and peeling can be performed substantially simultaneously. The optimum printed precision can thus be maintained, the shape can be made uniform, and printing can be performed automatically so that a printed object is obtained that has no uneven printing and possesses a high aspect ratio, thick application, and reproducible resolution of application.

According to the fifth aspect of the present invention, the portion of the printed object to which the coating material is sequentially transferred can be rapidly peeled from the screen plate in conjunction with the movement of the squeegee.

According to the sixth aspect of the present invention, a constant peel angle of the screen plate facilitates peeling of the screen plate from the printed object and enables uniform peeling.

According to the seventh aspect of the present invention, when the parameters of the servo motors are set by the control unit, a subsequent continuous operation can be automatically controlled by numeric control.

According to the eighth aspect of the present invention, the end part of the screen plate can be reliably prevented from bending by the fixing mechanism that can rotate with respect to the support bodies regardless of the position of the vertically moving support bodies.

According to the ninth aspect of the present invention, the tilt plate naturally tilts and the tension on the screen plate can be kept constant even when the tension of the screen plate is not adjusted by the tension mechanism in conjunction with the vertical movement of the support bodies, and the end part of the screen plate can be reliably prevented from bending.

According to the tenth aspect of the present invention, when one of the support bodies is moved upward, this support body naturally tilts so as to approach the screen plate, the fixing mechanism provided to the other support body also naturally rotates, and it is possible to reliably prevent both end parts of the screen plate from bending, while keeping the tension on the screen plate constant.

### BEST MODE FOR CARRYING OUT THE INVENTION

Preferred examples of the present invention will be described hereinafter.

### Example 1

The structure will first be described. In FIG. 1, both ends of a flexible screen plate 2 are supported between support bodies 1A, 1B that are spaced apart to the left and right and are capable of moving upward and downward. The flat screen plate 2 has a coating material passage part or conduit (not shown) that forms the shape to be printed, and the screen plate 2 may be composed of a polymer material or a metal material. Some screen plates are made of both these materials. The support bodies 1A, 1B may be in the form of rollers or polygons. A squeegee unit 5 composed of two squeegees 3A, 3B and a discharge port 4 for discharging a coating material 34 (see FIG. 4) is provided above the screen plate 2. The coating material 34 may be any material that can be used in screen printing, such as the one for silkscreen printing, a paste, a solder particle paste, or the like.

A printed-object holder 7 for holding, e.g., a wafer or the like, for example, as the printed object 6 onto which the coating material 34 is printed is provided under the screen plate 2, and the printed-object holder 7 is configured so that the position of the printed object 6 is varied by an alignment table 8. The alignment table 8 is fixed above a sliding table 9, and is configured so as to slide in guides 10A, 10B to move to forward and backward positions in relation to the support bodies 1A, 1B disposed on the left and right. The alignment table 8 may be operated by air or a motor. LM guides or the like, for example, may be used as the guides 10A, 10B.

The guides 10A, 10B and guide parts 11A, 11B for moving the support bodies 1A, 1B in the vertical direction are attached directly or via another component to a rack 12 that forms the outline of the device.

In other words, the structure of the screen printer is characterized in comprising a flat screen plate 2 having a coating material passage part that forms the shape to be printed; support bodies 1A, 1B for supporting the screen plate 2; support body drive means D1 shown in FIG. 2 for driving the support bodies 1A, 1B upward and downward; a printed-object holder 7 for supporting the printed object 6 in a position of contact with the printed surface; and squeegees 3A, 3B for transferring the coating material 34 to the printed object 6 through the coating material passage part by rubbing the coating material 34 against the screen plate 2.

FIG. 2 will be used to describe only the support body 1A on the right side, which is one of the support bodies 1A, 1B that are disposed on the left and right sides and are capable of moving upward and downward.

The support body 1A is supported in the screen printer between supports 14A of a movable body 13A. The support body 1A may be fixed or capable of rotating using the supports 14A as support points. The movable body 13A is driven by a servo motor 16 and can move upward and downward via a screw 15 and a nut 17. The movable body 13A can be driven upward and downward, and is configured so that the forward and backward oscillation of the movable body 13A is guided by two guide parts 11A. The motor 16 and a bearing 18 are fixed to a portion of the rack 12. In other words, the movable body 13A, the screw 15, the servo motor 16, the nut 17, and the bearing 18 are provided as the aforementioned drive means D1. The screw 15 may be a ball screw, and the nut 17 may be a spline. The drive power is not limited by the servo motor 16 and the control device thereof, and may be supplied by a motor or a pneumatic cylinder, but the control device must be designed for precise operation. The drive means D1 of the support body 1A and the drive means D1 of the support body 1B are bilaterally symmetrical and operate in the same manner.

The drive means D1 for moving the position of the support bodies 1A, 1B upward and downward may be capable of driving the support bodies 1A, 1B separately or together, and the objects of the present device can be achieved by a configuration in which only one of the support bodies 1A, 1B can be driven upward and downward.

The object of the present screen printer in preventing wrinkles and the like in the screen plate is achieved by a configuration that comprises the support bodies 1A, 1B for supporting a flat screen plate 2 having a coating material passage part that forms the shape to be printed; driving means D1 for driving the support bodies 1A, 1B upward and downward; and a tension mechanism and fixing mechanism (see FIG. 3) of the screen plate 2 that operate in conjunction with the drive means D1 of the support bodies 1A, 1B.

FIG. 3 shows the tensioning and fixing mechanisms for the screen plate 2. The tensioning and fixing mechanism on the right side will be described. The screen plate 2 is supported between the support bodies 1A, 1B that can be driven upward and downward by the drive means D1, and are disposed on the left and right sides, and an end of the screen plate 2 is fixed and held between a drive piece 19A and a clamp piece 20A. The drive piece 19A is driven by a pneumatic cylinder 21A. The drive piece 19A, the clamp piece 20A, and the pneumatic cylinder 21A that form the mechanism for fixing the screen plate 2 can be driven upward and downward by a pneumatic cylinder 22A, which is the mechanism for tensioning the screen plate 2, via a bracket 23A. The pneumatic cylinder 22A is fixed to the movable body 13A. The left and right tensioning and fixing mechanisms are bilaterally symmetrical, and a support body 1B, a drive piece 19B, a clamp piece 20B, a pneumatic cylinder 21B, a pneumatic cylinder 22B, and a bracket 23B are also provided on the left side.

FIG. 4 shows the squeegee unit 5. The squeegees 3A, 3B are plate-shaped components for rubbing the coating material onto the screen plate 2, and have the same width as the screen plate 2. The squeegee is also sometimes referred to as a squilgee. The squeegee 3A can be moved up and down by a pneumatic cylinder 25A via a squeegee support 24A. The pneumatic cylinder 25A is fixed to a rack 26A that is the base of the squeegee unit 5. The squeegees 3A, 3B, the squeegee supports 24A, 24B, and the pneumatic cylinders 25A, 25B are disposed symmetrically to each other on the left and right.

The discharge port 27 for the coating material is a nozzle that has one or more discharge holes, and is fixed between the racks 26A, 26B of the squeegee unit 5. The coating material 34 is fed by a tube from above the racks 26A, 26B of the squeegee unit 5.

The squeegee unit 5 is thus formed by the components provided to the racks 26A, 26B of the squeegee unit 5. The squeegee unit 5 can be driven upward and downward by a nut 28, a screw 29, a servo motor 30, and the numeric control device thereof that constitute a squeegee vertical drive means D2. The racks 26A, 26B of the squeegee unit 5 and the components attached thereto can be driven by a nut 31, a screw 32, a servo motor 33, and the numeric control device thereof that constitute a squeegee horizontal drive means D3 so that the squeegee unit 5 can move left and right between the support bodies 1A, 1B. The nut 31 and the nut 28 may be splines, and the screw 29 and screw 32 may be ball screws. The servo motors 30, 33 may be substituted with normal motors or pneumatic cylinders, but a design must be provided for precise control thereof. The squeegee supports 24A, 24B and the pneumatic cylinders 25A, 25B are also bilaterally symmetrical.

The squeegee unit 5 is thus a unit of the screen printer that is characterized in comprising squeegees 3A, 3B of the squeegee unit 5 for transferring the coating material 34 to the printed object 6 through the coating material passage part by rubbing the coating material 34 onto the screen plate 2; the drive means D2 for driving the squeegees 3A, 3B upward and downward; and the numeric control device for controlling the drive means D2. The squeegee unit 5 has two squeegees 3A, 3B, but there may also be only one squeegee and mechanism for operating the squeegee.

The screen printer is characterized in comprising a control unit that is composed of a numeric control device for the servo motor 16 (FIG. 2) of the drive means D1 that enables the support bodies 1A, 1B of the screen plate 2 to be driven upward and downward; a numeric control device for the servo motor 30 (FIG. 4) for driving the squeegees 3A, 3B of the squeegee unit 5 upward and downward; and a numeric control device for the servo motor 33 (FIG. 4) for driving the squeegees 3A, 3B of the squeegee unit horizontally.

Microcomputer control is generally used for the numeric control device, but a portion of the numeric control device may be a sequence control device. The control device is a common device, and no particular description thereof will be given.

The method of operation of the screen printer will be described hereinafter. A wafer or other printed object 6 in front is first placed on the printed-object holder 7 for supporting the printed object 6 in a position of contact with the printed surface, and the printed object 6 can move to a position under the screen plate 2. The printed-object holder 7 is fixed on the alignment table 8, and can be adjusted in the X, Y, and theta directions so that the wafer or other printed object 6 is aligned in the optimum position. The alignment table 8 fixed on the sliding table 9, the printed-object holder 7, and the printed object 6 fixed to the printed-object holder 7 can be stopped in a position under the screen plate 2.

At this time, both ends of the screen plate 2 supported by the support bodies 1A, 1B are clamped by the drive pieces 19A, 19B and the clamp pieces 20A, 20B through the driving of the pneumatic cylinders 21A, 21B. The drive pieces 19A, 19B and the clamp pieces 20A, 20B are pulled downward by the pneumatic cylinders 22A, 22B, tension is applied to the screen plate 2 by an appropriate setting of air pressure, and the appropriate amount of tension can be maintained without flexing the screen plate 2. In the present example, both ends of the screen plate 2 are pulled by the tension mechanism, but a configuration may also be adopted in which one end is fixed by the fixing mechanism, and only one end is pulled by the tension mechanism.

As shown in FIG. 5, in the operation of the sliding table 9, the screen plate 2 is supported by the support bodies 1A, 1B in a position several millimeters above the printed object 6 so that the printed object 6 and the screen plate 2 do not touch, and the printed object 6 can enter the space under the screen plate 2 without touching or interfering with the screen plate 2.

As shown in FIG. 6, when the printed object 6 is positioned under the screen plate 2, the support bodies 1A, 1B descend, and the screen plate 2 is held in a position in which an appropriate gap is provided between the screen plate 2 and the printed object 6.

When the printed object 6 is set on the printed-object holder 7 and supported by the sliding table 9 in the position for printing of the screen plate 2 by this sequence of operations, an arbitrary gap can be provided between the back surface of the screen plate 2 and the surface of the printed object 6 by the vertical movement of the support bodies 1A, 1B by the drive means D1. Interference between the screen plate 2 and the printed object 6 can therefore be prevented, and the printed object 6 can easily be set under the screen plate 2.

When the squeegee used at this time is squeegee 3A as shown in FIG. 7, the squeegee 3A is moved downward by the operation of the pneumatic cylinder 25A, and the squeegee 3B is moved upward by the operation of the pneumatic cylinder 25B. The squeegee 3A is moved further downward by the operation of the structure composed of the servo motor 30, the nut 28, and the screw 29, and the squeegee 3A can be stopped on the screen plate 2 in a precisely measured position. The squeegee 3A may also be brought into contact with the screen plate 2 for printing according to the type of the screen plate 2 or coating material 34, the thickness of the printing, and the operating properties.

The coating material 34 is applied to the surface of the screen plate 2 from the discharge port 27; the coating material 34 is somewhat uniformly applied on the screen plate 2 by the left, right, and angled movement of the squeegee unit 5; and the screen plate 2 and the squeegee 3A can move while a constant height is maintained.

The squeegee 3A moves from right to left while applying the coating material 34 at a uniform thickness on the screen plate 2 in conjunction with the movement of the squeegee unit 5. The support body 1A moves upward together with the movement of the squeegee 3A, and the screen plate 2 bends upward using the squeegee 3A as a support point as shown in FIG. 7, and is peeled from the right side to the left side of the printed object 6.

At this time, the movement speed of the support body 1A is adjusted so that the printed coating material 34 is not peeled from the printed object 6 by the upward and downward movement of the support body 1A, and peeling can be completed with the screen plate 2 in the optimum position.

The pneumatic cylinder 22A moves the drive piece 19A, the clamp piece 20A, and the pneumatic cylinder 21A upward so that a constant tension is applied to the screen plate 2 in conjunction with the upward movement of the support body 1A, and one end of the screen plate 2 is adjusted to the appropriate position. The support body 1A can thus be driven upward and downward in conjunction with the driving of the tension mechanism. Therefore, “wrinkling” or “waves” in the screen plate 2 can be prevented at all times, and the tension applied to the screen plate 2 can be kept constant regardless of the vertical movement of the support bodies 1A, 1B.

The coating material 34 is also printed onto the printed object 6 through the coating material passage part of the screen plate 2 in conjunction with the movement of the squeegee 3A, and the support body 1A on the opposite side from the movement direction of the squeegee 3A is raised in the direction in which the screen plate 2 separates from the printed object 6, whereby the screen plate 2 can be immediately peeled from the printed object 6 after printing by the squeegee 3A, and peeling can be performed while the coating material 34 is still soft and of a low viscosity. Automatic control of the peeling speed and the amount of height movement of the screen plate 2 and the support bodies 1A, 1B makes it possible to provide precise and thick screen printing by a simple operation.

In summary, the drive means D1 that is the driving device in the present screen printer has a function whereby the screen plate 2 is supported by the support bodies 1A, 1B that can each be driven upward and downward, one of the support bodies is moved to a high position, and the screen plate 2 is peeled from the printed surface of the printed object 6 using the distal end of the squeegee 3A or squeegee 3B as a support point.

The present device uses the servo motors 16, 30, 33 to drive the support bodies 1A, 1B upward and downward, and drive the left-right movement and up-down movement of the squeegee unit 5 in order to give the coating material 34 on the upper surface of the screen plate 2 a uniform thickness. After the parameters of the servo motors are set, the sequence of operations can be automatically performed through numeric control.

The coating material 34 after peeling of the screen plate 2 can thus have a width of 60 microns and a height of 50 microns. The coating material 34 can also thus be uniformly printed on the printed object 6 at all times.

In other words, the parameters of numeric control by the numeric control devices of the drive means D2, D3 are set for the relationship between the speed and the amount of movement of the squeegees 3A, 3B in the horizontal and vertical directions, the two support bodies 1A, 1B can be moved to the optimum height by the numeric control of the numeric control device of another drive means D1 in screen printing of the coating material 34, and printing and peeling can be performed substantially simultaneously. The optimum printed precision can thus be maintained, the shape can be made uniform, and printing can be performed automatically so that a printed object is obtained that has no uneven printing and possesses a high aspect ratio, thick application, and reproducible resolution of application.

After such an operation, the coating material on the screen plate 2 is gathered by the right-to-left movement of the squeegee 3A. The squeegee unit 5 moves from left to right through the squeegee 3B symmetric with the squeegee unit 3A to perform printing, the support body 1B is raised, and the screen plate 2 is peeled from the printed object 6 and used in the subsequent screen printing process.

The support bodies 1A, 1B were described as being capable of moving upward and downward in the present example, but a configuration may be adopted in which any one of the support bodies 1A, 1B is capable of moving upward and downward.

In this manner, when the screen plate 2 is peeled from the printed object 6 while the squeegees 3A, 3B are moved, the vertical position of the support bodies 1A, 1B can be controlled via the drive means D1 by the control device so that the peel angle of the screen plate 2 with respect to the printed object 6 can be set constant at all times about the moving squeegees 3A, 3B as support points, and peeling can be performed easily and uniformly. Screen printing can thus be performed in which the coating material 34 on the screen plate 2 is thicker and more uniform.

In the present example, the drive means D3 is provided for moving the squeegees 3A, 3B horizontally, the coating material 34 is transferred to the printed object 6 through the coating material passage part by the horizontal movement of the squeegee 3A, and the drive means D1 is configured so as to move the support body 1A positioned on the opposite side in the horizontal movement direction of the squeegee 3A upward so that the screen plate 2 separates from the printed object 6. Therefore, the portion of the printed object 6 to which the coating material 34 is sequentially transferred can be rapidly peeled from the screen plate 2 in conjunction with the movement of the squeegee 3A.

A control device for controlling the vertical position of the support bodies 1A, 1B via the drive means D1 is provided so that the peel angle of the screen plate 2 is constant when the screen plate 2 is peeled from the printed object 6 while the squeegees 3A, 3B are moved. A constant peel angle of the screen plate 2 thus facilitates peeling of the screen plate 2 from the printed object 6 and enables uniform peeling.

Through the use of the servo motors 16, 30, 33 as drive sources of the drive means D1, D2, D3, setting the parameters of the servo motors 16, 30, 33 by the control unit allows a subsequent continuous operation to be automatically controlled by numeric control.

### Example 2

FIG. 8 shows a plan view and a right-side view of the present device. FIG. 9 is a front view of the support body 35A on the right side. The tensioning and fixing mechanism for the screen plate will be described based on FIG. 9.

Support bodies 35A, 35B that are capable of moving upward and downward are spaced apart to the left and right. The left and right side parts of a rack 36 are supported by a shaft 37 at the support bodies 35A, 35B. A screen plate 38 is held between movable pieces 39A, 39B and clamp pieces 40A, 40B, and is fixed by screws 41A, 41B. Specifically, the movable pieces 39A, 39B, the clamp pieces 40A, 40B, and the screws 41A, 41B constitute a mechanism for fixing the flexible screen plate 38. The tensioning pieces 39A, 39B are moved by air cylinders 42A, 42B that constitute a mechanism for tensioning the screen plate 38 so that the screen plate 38 is pulled in the horizontal direction, and are held by air pressure. The movable pieces 39A, 39B are guided by a guide post 49 when driven by the air cylinders 42A, 42B.

FIG. 10 shows the drive means D11 that is the drive unit of the support body 35A. The support body 35A is driven by a servo motor 16, and can be moved upward and downward by a screw 15 and a nut 17. In the drive unit of the present Example 2, a motor 16 is fixed to a fixing plate 44, and the fixing plate 44 and a bearing 18 are fixed to a tilt plate 43. The screw 15 and the servo motor 16 are connected by a joint 45. The screw 15 may be a ball screw, and the nut 17 may be a spline. In other words, the screw 15, the servo motor 16, the nut 17, the bearing 18, and the joint 45 are provided as the drive means D11′. The drive power is not limited by the servo motor 16 and the control device thereof, and may be supplied by a motor or a pneumatic cylinder, but the control device must be designed for precise operation. The tilt plate 43 is supported by a bearing 46, a bearing 47, and a shaft 48 in a rack 12 that forms the outline of the device.

FIG. 11 shows the drive means D11′ that is the drive unit of the left support body 35B. The support body 35B is driven by the servo motor 16 and can be moved upward and downward by the screw 15 and the nut 17. The motor 16 is fixed to the fixing plate 44, and the fixing plate 44 and the bearing 18 are fixed to the rack 12. The screw 15 and the servo motor 16 are connected by the joint 45. The screw 15 may be a ball screw, and the nut 17 may be a spline. In other words, the screw 15, the servo motor 16, the nut 17, the bearing 18, and the joint 45 are provided as the drive means D11′. The drive power is not limited by the servo motor 16 and the control device thereof, and may be supplied by a motor or a pneumatic cylinder, but the control device must be designed for precise operation. Example 2 thus configured differs with respect to the mechanism of the drive units of the support body 35A and the support body 35B. The difference is that only one of the drive means D11 is attached and fixed to the tilt plate 43 rotatably provided to the rack 12. Other structural aspects and aspects of the operation of the squeegee unit 5 are the same as in Example 1.

Therefore, FIG. 12 will be used to describe a state in which the left support body 35A is raised. FIG. 12 shows a case in which the screen plate 38 is peeled from the printed object 6 while the support body 35A on the right side is in a higher position than the support body 35B on the left side.

In the present example, the screen plate 38 is clamped and fixed by the movable pieces 39A, 39B and the clamp pieces 40A, 40B. Since the screen plate 38 is fixed in this manner, when a drive mechanism of the same type as the drive mechanism of the right-side support body 35A is also provided to the left side, the screen plate 38 is kept horizontal, and the portion of the screen plate 38 that is clamped by the movable pieces 39A, 39B and the clamp pieces 40A, 40B is bent insofar as the support body 35A and the support body 35B are not moved upward and downward.

In the drive mechanism of the support body 35A, the bearing 46, the bearing 47, and the shaft 48 are provided so that the tilt plate 43 can naturally tilt inward about the shaft 48. A rack 36 supported by the support body 35B can tilt about the shaft center 49.

The drive means D11, D11′ for moving the position of the support bodies 35A, 35B upward and downward may be capable of driving the support bodies 35A, 35B separately or together, and the objects of the present device can be achieved by a configuration in which only one of the support bodies 35A, 35B can be driven upward and downward.

In the same manner as in Example 1, the object of the present screen printer in preventing wrinkles and the like in the screen plate 38 is achieved by a configuration that comprises the support bodies 35A, 35B for supporting a flat screen plate 38 having a coating material passage part that forms the shape to be printed; drive means D11, D11′ for driving the support bodies 35A, 35B upward and downward; a printed-object holder 7 for supporting the printed object 6 in a position of contact with the printed surface; and squeegees 3A, 3B for transferring the coating material 34 to the printed object 6 through the coating material passage part by rubbing the coating material 34 onto the screen plate 38, wherein the present device is characterized in comprising a tension mechanism and fixing mechanism (see FIG. 9) of the screen plate 38 that operate in conjunction with the drive means D11, D11′ of the support bodies 35A, 35B.

In the present example, a fixing mechanism for fixing an end of the screen plate 2 is furthermore provided, and the fixing mechanism is provided so as to be able to rotate about a shaft 37 or the like, for example, with respect to the support bodies 35A, 35B. In this configuration, the end part of the screen plate 38 can be reliably prevented from bending by the fixing mechanism that can rotate with respect to the support bodies 35A, 35B regardless of the position of the vertically moving support bodies 35A, 35B.

A tilt mechanism (tilt plate 43, bearing 46, bearing 47, and shaft 48) is also provided for tilting the support body 35A so as to approach the screen plate 38 when the support body 35A is moved into a high position. In this configuration, the support body 35A naturally tilts, and the tension on the screen plate 38 can be kept constant even when the tension of the screen plate 38 is not adjusted by the tension mechanism in conjunction with the vertical movement of the support body 35A, and the end part of the screen plate 38 can be reliably prevented from bending.

Furthermore, in a configuration in which such a tilt mechanism is provided to the support body 35A, and fixing mechanisms for fixing one end and the other end of the screen plate 38 are disposed at one support body 35A and the other support body 35B, it is preferred that at least the fixing mechanism disposed at the other support body 35B be provided so as to be able to rotate with respect to the other support body 35B. According to this configuration, when one support body 35A is moved upward, the support body 35A naturally tilts so as to approach the screen plate 38, and the fixing mechanism provided to the other support body 35B also naturally rotates, making it possible to prevent both end parts of the screen plate 38 from bending while keeping the tension on the screen plate 38 constant.

The screen printer of the present invention is not limited to applications in which a paste is printed onto a wafer, and can also be used for cream solder in which a coating material and solder particles are dispersed in an organic solvent or the like, resist materials used as masks for manufacturing printed boards, resin starting materials in an uncured state, and the like. In the present invention, since a thick coating can be properly formed in any thickness, the present invention is particularly suitable when the abovementioned materials are printed in processes for manufacturing printed boards or semiconductor elements, solar cell panels, displays, sensors, and the like, for example.

### BRIEF DESCRIPTION OF THE DRAWINGS

FIG. 1 is a perspective view showing an overview of the entire screen printer of the present invention;

FIG. 2 is a side view showing the relevant parts of a support body drive unit of the present invention;

FIG. 3 is a front view showing the relevant parts of the tension and fixing mechanism of the screen plate of the present invention;

FIG. 4 is a front view showing the relevant parts of the squeegee unit for operating the squeegees of the present invention;

FIG. 5 is a schematic view showing the state of the printed object and the screen plate that occurs through movement of the sliding table;

FIG. 6 is a schematic view showing the state of the printed object and the screen plate during printing;

FIG. 7 is a schematic view showing the peeling of the printed object and the screen plate;

FIG. 8 is a plan view and a side view showing relevant parts that include the support bodies of Example 2;

FIG. 9 is a front view showing the relevant parts of the tension and fixing mechanism on the right side in Example 2;

FIG. 10 is a side view showing the relevant parts of the drive mechanism of the support body on the right side in Example 2;

FIG. 11 is a side view showing the relevant parts of the drive mechanism of the support body on the left side in Example 2; and

FIG. 12 is a front view showing the relevant parts in a state in which the support body on the right side in Example 2 is raised.

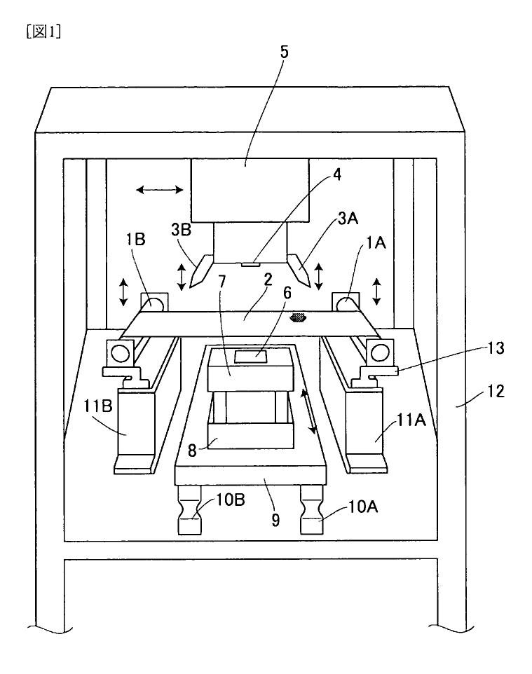

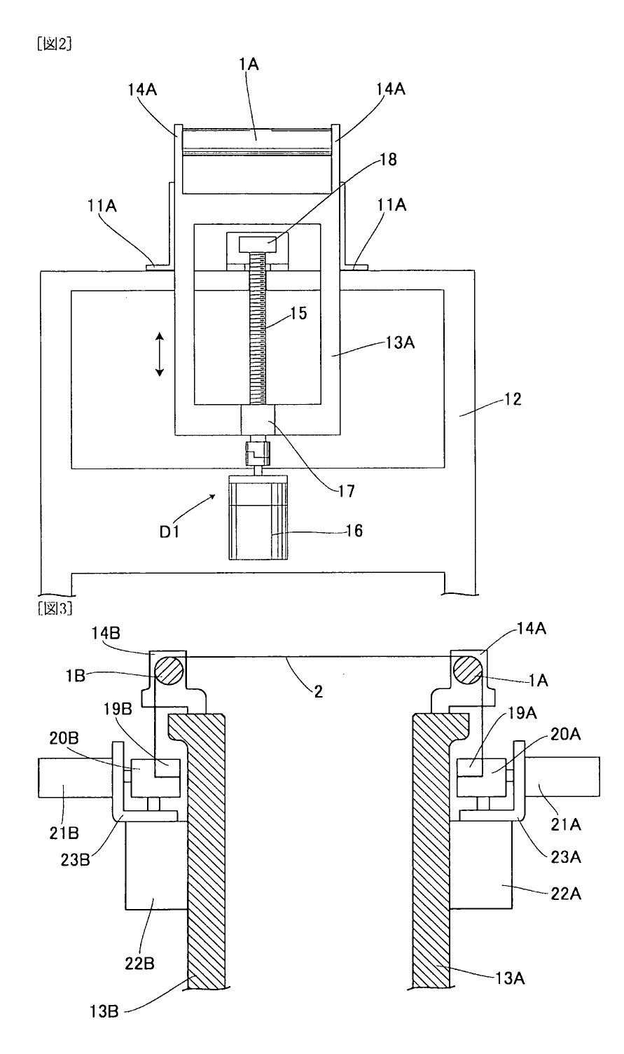

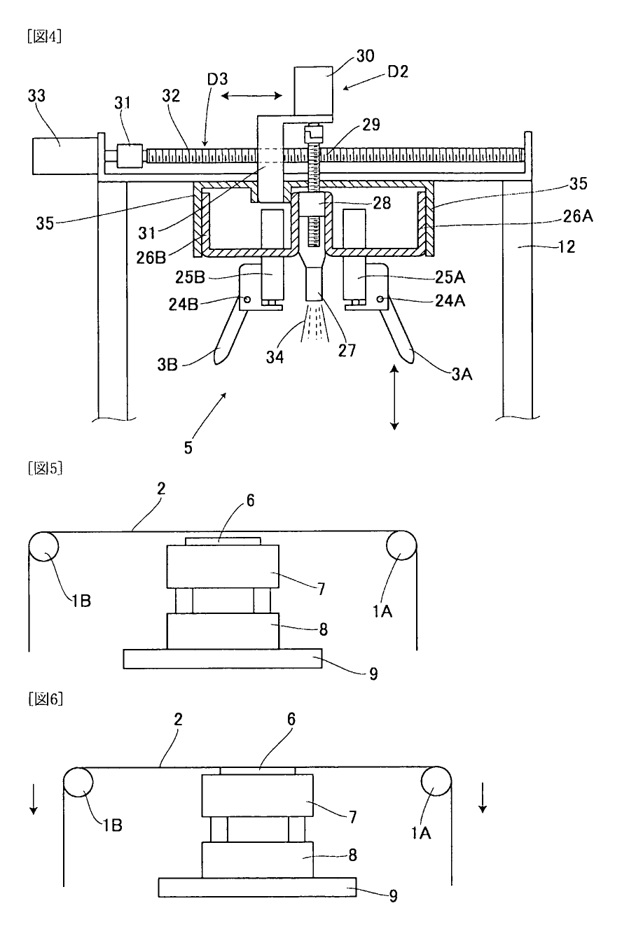

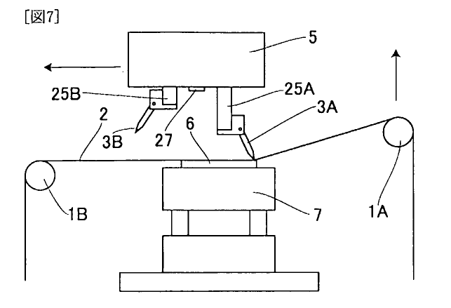

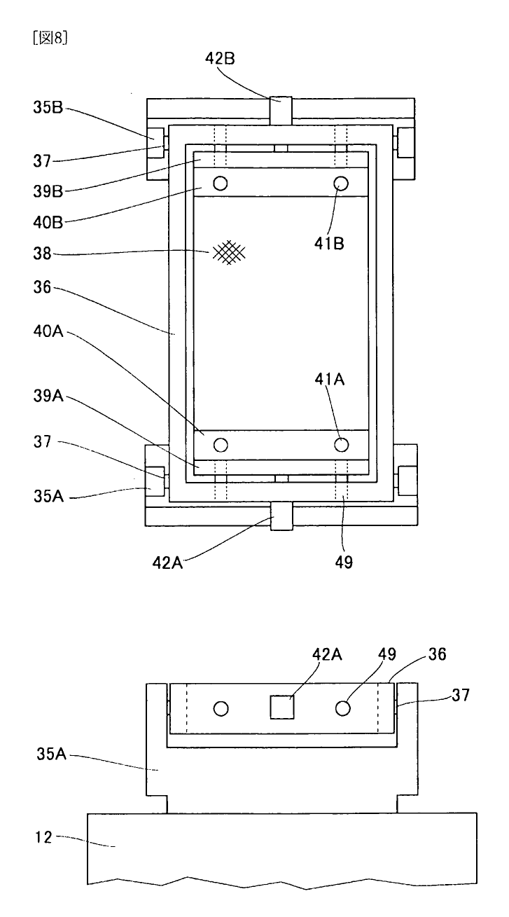

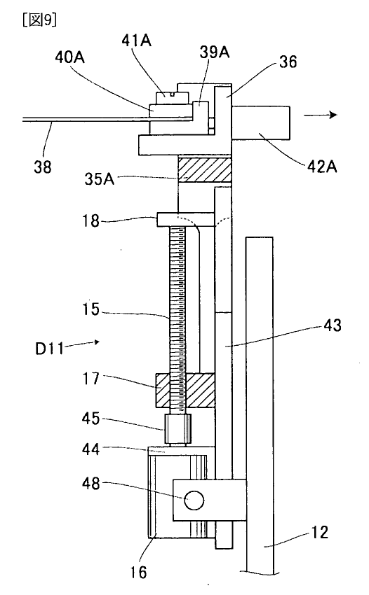

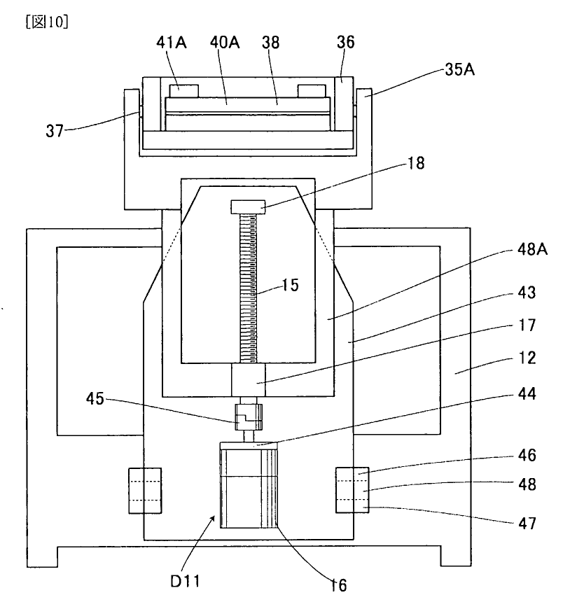

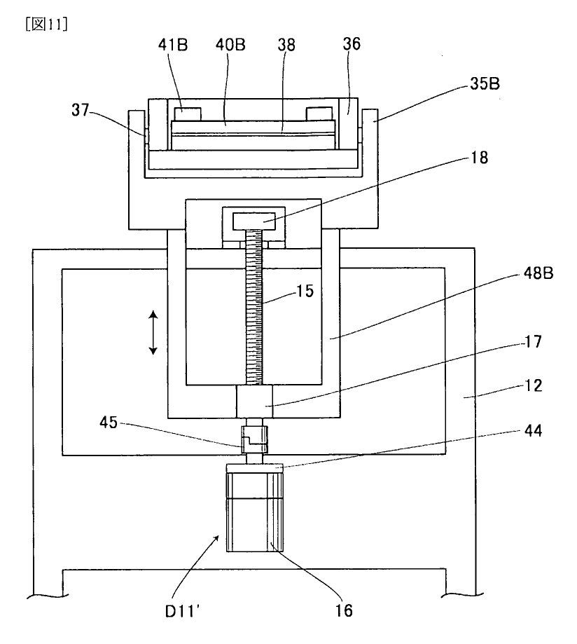

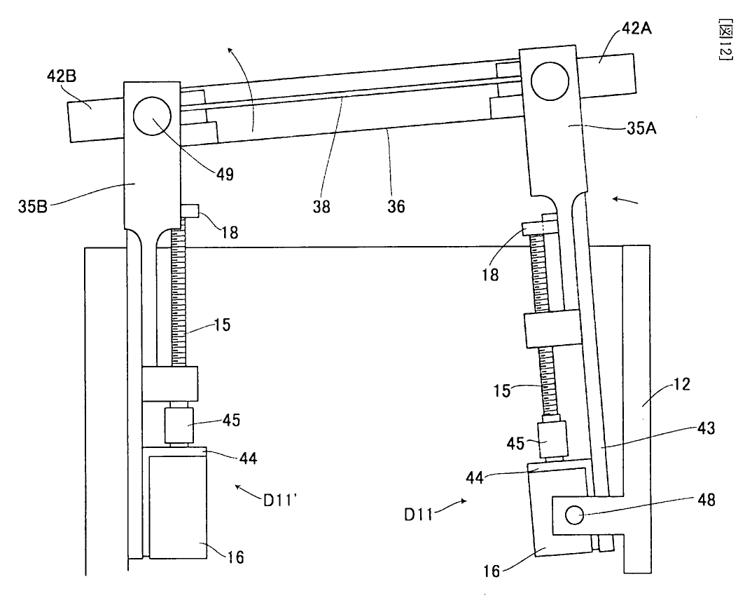

### KEY

1A, 1B: support bodies
2: screen plate
3A, 3B: squeegees
6: printed object
7: printed-object holder
16, 30, 33: servo motors
19A, 19B: drive pieces (fixing mechanism)
20A, 20B: clamp pieces (fixing mechanism
21A, 21B: pneumatic cylinders (fixing mechanism)
22A, 22B: pneumatic cylinders (tension mechanism)
34: coating material
35A, 35B: support bodies
38: screen plate
43: tilt plate (tilt mechanism)
46: bearing (tilt mechanism)
47: bearing (tilt mechanism)
48: shaft (tilt mechanism)
D1, D11, D11′: drive means (support body drive means)
D2: drive means (squeegee vertical drive means)
D3: drive means (squeegee horizontal drive means)

1. A screen printer characterized in comprising:
a screen plate having a coating material passage part that forms a shape to be printed;
support bodies for supporting said screen plate that are spaced apart on a left and right;
support body drive means for driving said support bodies upward and downward;
a printed-object holder for supporting a printed object in a position of contact under said screen plate; and
a squeegee for transferring a coating material to the printed object through said coating material passage part by rubbing the coating material against said screen plate, wherein
said support body drive means moves each of said support bodies upward and downward to provide an appropriate space between said screen plate and said printed object in a state in which said printed object is set on said printed-object holder, after which one of said support bodies is moved to a high position, and said screen plate is peeled from said printed object using a distal end of said squeegee as a support point.

2. (canceled)

3. The screen printer according to claim 1, characterized in comprising a tensioning and fixing mechanism of said screen plate for operating in conjunction with said support body drive means.

4. The screen printer according to claim 1, characterized in comprising a control unit having:
a numeric control device of said support body drive means that enables upward and downward driving of said support body;
a numeric control device of squeegee vertical drive means for driving said squeegee upward and downward; and
a numeric control device of squeegee horizontal control means for driving said squeegee in a horizontal direction.

5. The screen printer according to claim 1, characterized in further comprising squeegee horizontal drive means for moving said squeegee in a horizontal direction, wherein said support body drive means is configured so that a coating material is transferred to a printed object through said coating material passage part by movement of said squeegee, and said support body positioned on an opposite side in a movement direction of said squeegee is moved in a direction in which said screen plate is separated from said printed object.

6. The screen printer according to claim 5, characterized in comprising a control device for controlling a position of said support body in a vertical direction via said support body drive means so that a peeling angle of said screen plate is constant when said screen plate is peeled from said printed object while said squeegee is moved.

7. The screen printer according to claim 4, characterized in that a servo motor is used as a drive source of said support body drive means, said squeegee vertical drive means, and said squeegee horizontal drive means.

8. The screen printer according to claim 1, characterized in further comprising a fixing mechanism for fixing an end part of said screen plate, wherein said fixing mechanism is provided so as to be able to rotate with respect to said support body.

9. The screen printer according to claim 1, characterized in further comprising a tilt mechanism for tilting said one support body towards said screen plate when said support body is moved to a high position.

10. The screen printer according to claim 9, characterized in that
a fixing mechanism for fixing one end and another end of said screen plate is provided to each of said one support body and the other support body; and
said fixing mechanism provided to at least said other support body is allowed to rotate with respect to the other support body.
